(19) United States
(12) Patent Application Publication
(10) Pub. No.: US 2024/0118865 A1
(43) Pub. Date: Apr. 11, 2024

(54) USER INTERFACE CONTROL FOR CONTACTLESS IN-PERSON TRANSACTION VIA SOUND

(71) Applicant: CoinCircle, Inc., Santa Monica, CA (US)

(72) Inventors: Erick Stephen Miller, Marina Del Rey, CA (US); Ruslan G.M. AlJabari, Stanford, CA (US); Alejandro Saavedra, Sunland, CA (US)

(21) Appl. No.: 18/376,777

(22) Filed: Oct. 4, 2023

Related U.S. Application Data
(60) Provisional application No. 63/414,430, filed on Oct. 7, 2022.
(60) Provisional application No. 63/425,171, filed on Nov. 14, 2022.
(60) Provisional application No. 63/414,425, filed on Oct. 7, 2022.

(51) Int. Cl. G06F 3/16; G06F 3/0484; G06Q 20/40

(52) U.S. Cl. CPC G06F 3/167; G06F 3/0484; G06Q 20/401

(57) ABSTRACT

Systems and computer-implemented methods for displaying a user interface for contactless in-person transaction via sound are provided herein. The system includes a sender device configured to generate and transmit sound signals that encode a package associated with a transaction request through speakers of the sender device. The system also includes a receiver device having a graphical user interface configured to display one or more graphical elements to guide a user to align the receiver device in a physical orientation that aligns a microphone of the receiver device with a speaker of a sender device, and a wave progressing in a direction that aligns with the speaker's broadcast direction of the sound signals.

### CROSS REFERENCE TO RELATED APPLICATIONS

This application claims the benefit of U.S. Provisional Patent Application Ser. No. 63/414,430, filed on Oct. 7, 2022, U.S. Provisional Patent Application Ser. No. 63/425,171, filed on Nov. 14, 2022, and U.S. Provisional Patent Application Ser. No. 63/414,425, filed Oct. 7, 2022, which are incorporated by reference herein for all purposes.

### SUMMARY

Embodiments relate to a computer-implemented method, including: causing a graphical user interface of a receiver device to display one or more graphical elements to guide a user to align the receiver device in a physical orientation that aligns a microphone of the receiver device with a speaker of a sender device; transmitting sound signals that encode a package associated with a transaction request through the speaker of the sender device to the microphone of the receiver device; and causing the graphical user interface to display of a wave progressing in a direction that aligns with the speaker's broadcast direction of the sound signals.

In some embodiments, a non-transitory computer-readable medium that is configured to store instructions is described. The instructions, when executed by one or more processors, cause the one or more processors to perform a process that includes steps described in the above computer-implemented methods or described in any embodiments of this disclosure. In some embodiments, a system may include one or more processors and memory coupled to the processors that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. (Figure) 1 is an example system environment, in accordance with some embodiments.

FIG. 2 is a flowchart depicting an example process for performing a transaction using in-person contactless communication protocol, in accordance with some embodiments.

FIG. 3A is a flowchart illustrating an example process for application to initiate and verify a transaction request, in accordance with some embodiments.

FIG. 3B is a flowchart illustrating another example process for application to initiate and verify a transaction request, in accordance with some embodiments.

FIG. 4 is a block diagram illustrating an example overall transaction process in both the transmitter and receiver sides.

FIGS. 5A and 5B, combined, are a graphical flowchart that illustrates the change in the graphical user interface of the application in an initiation of an example transaction request, in accordance with some embodiments.

FIGS. 5C and 5D, combined, are a graphical flowchart that illustrates the change in the graphical user interface of the application in receiving a transaction request on a receiver user device 110, in accordance with some embodiments.

FIG. 5E is a conceptual diagram showing a confirmation notification on the transmitter user device, in accordance with some embodiments.

FIGS. 5F and 5G, combined, illustrate an example process for user digital item verification that may be carried by the application, in accordance with some embodiments.

FIG. 6A through FIG. 6D illustrates an example of a user wanting to broadcast a transaction to 3 nearby devices, in accordance with some embodiments.

FIG. 6E through FIG. 6F illustrates transactions between pairs of devices while other devices are in proximity, accordance with some embodiments.

FIG. 7A is a block diagram illustrating a chain of transactions broadcasted and recorded on a blockchain, in accordance with an embodiment.

FIG. 7B is a block diagram illustrating a connection of multiple blocks in a blockchain, in accordance with an embodiment.

FIG. 8 is a block diagram illustrating components of an example computing machine that is capable of reading instructions from a computer-readable medium and execute them in a processor.

The figures depict, and the detail description describes, various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

FIG. 1 is a block diagram that illustrates a system environment 100 of an example computing server, in accordance with an embodiment. By way of example, the system environment 100 includes two or more user devices 110, a transaction record server 130, a data store 135, a blockchain 150, and an autonomous program protocol 155. The entities and components in the system environment 100 communicate with each other through the network 160. In addition, the user devices 110 may communicate with each other and conduct transactions directly in-person through high frequency sound that is nearly inaudible or inaudible sound or near ultrasound or ultrasound that is generated by the speakers 112 of the user devices 110. High-frequency sound may include audio waveforms that may be near-ultrasound that may be either inaudible waveforms or nearly inaudible waveforms and also may include ultrasound or near ultrasound. In some embodiments, the sound signals may have the frequencies in the inaudible ranges of 20,000 Hz to 24,000 Hz and in the less inaudible range of 16,000 Hz to 19,000 Hz. The volumes of the devices may be in the range of 1 dB to 84 dBs.

In various embodiments, the system environment 100 may include different, fewer, or additional components. The components in the blockchain system environment 100 may each correspond to a separate and independent entity or may be controlled by the same entity. For example, in some embodiments, the transaction record server 130 may control the data store 135.

While each of the components in the system environment 100 is often described in disclosure in a singular form, the system environment 100 may include one or more of each of the components. For example, there can be multiple user devices 110 conducting in person contactless transactions that will be discussed in further detail below. Each user device 110 is used by an end user and there can be millions or billions of end users in this system environment 100. Also, the transaction record server 130 may be part of a payment server that provides services to multiple end users that may operate different user devices 110. While a component is described in a singular form in this disclosure, it should be understood that in various embodiments the component may have multiple instances. Hence, in the system environment 100, there can be one or more of each of the components.

The user device 110 may include a speaker 112, a microphone 114, a user interface 116, and an application 118. In various embodiments, the user device 110 may include one or more of those components. In some embodiments, the user device 110 may include different, fewer, or additional components. A user device may also be referred to as a client device. A user device 110 may be controlled by a user who may be a customer of the transaction record server 130 or a participant of the blockchain 150. The user device 110 may be any computing device. Examples of user devices 110 include personal computers (PC), desktop computers, laptop computers, tablet computers, smartphones, wearable electronic devices such as smartwatches, or any other suitable electronic devices. In some embodiments, one of the user devices 110 may take the form of a payment device such as a point-of-sale (POS) device that may be a card reader but also include the capability to use the in-person contactless communication protocol described in various embodiments herein.

The users may use the in-person contactless communication protocol described in various embodiments herein to conduct transactions with each other. The transactions may include peer-to-peer direct transaction, such as direct payment, cryptocurrency or token transactions, whether through a cryptocurrency trading platform (e.g., an exchange, a broker, etc.) or directly on a blockchain, decentralized digital and cryptocurrency transactions, checkout, digital credit card payment, and other suitable transactions. Additionally, or alternatively, the users may also use the in-person contactless communication protocol to interact each other such as by sending messages and sharing files.

A user device 110 is equipped with a speaker 112 for transmitting high-frequency sound signals and a microphone 114 for receiving the high-frequency sound signals. While it may not be the primary design purpose, most smartphones or other electronic devices nowadays are equipped with microphone 114 that is capable of generating high-frequency sound signals in at least one or more frequency spectrums. As discussed in further detail below, one of the user devices 110 may use the speaker 112 to broadcast a message to initiate a communication under an in-person contactless communication protocol. The intended recipient user device 110 may receive the high-frequency sound signals through the microphone 114. The communication may be in a one-way mode or a two-way mode. In some embodiments, the two user devices 110 may use the in-person contactless communication protocol to complete a transaction or complete a file transfer. In some embodiments, the in-person contactless communication protocol may be used to establish an initial connection, such as a handshake procedure or to create a shared session key, and the two user devices 110 may in turn switch to another protocol such as WIFI to continue to communication.

The user device 110 may include a user interface 116 and an application 118. The user interface 116 may be the interface of the application 118 and allow the user to perform various actions associated with application 118. The application 118 may be a software application that allows a first user to generate a transaction (e.g., initiate a payment, transfer a file) for the in-person contactless communication protocol and a second user to complete the transaction (e.g., accept the payment or the file). The application 118 may provide various options such as selection of payment amount and linking of credit card, blockchain wallet, and bank accounts for the users. The application 118 may also provide functionalities to facilitate the completion of the transaction. For example, the application 118 on the recipient side may initiate the microphone 114 of the recipient user device 110 so that the user device 110 begins to actively listen to the high-frequency sound signal that is broadcasted by the sender user device 110. In another example, the application 118 may provide visual guidance for the user to physically align the user devices 110 in order for the high-frequency sound signal to be received. Upon completion of an in-person transaction, the application 118 may upload the record of the transaction to the transaction record server 130.

The user interface 116 may take different forms. In some embodiments, the user interface 116 is a software application interface. For example, the user interface 116 may be a front-end software application that can be displayed on a user device 110. In one case, the front-end software application is a software application that can be downloaded and installed on a user device 110 via, for example, an application store (App store) of the user device 110. In another case, the front-end software application takes the form of a webpage interface that allows clients to perform actions through web browsers. The front-end software application includes a graphical user interface (GUI) that displays various information and graphical elements.

A transaction record server 130 may be a server that provides various record keeping functionalities for the in-person transaction requests that occur between two user devices 110. In some embodiments, the operator of the transaction record server 130 may be the company that publishes the application 118 to allow users to conduct in-person transaction requests. In some embodiments, an in-person transaction request is a payment request from one user to another. The application 118 may upload the completed transaction record to the transaction record server 130 and the transaction record server 130 may reflect the change in balances in the user accounts (e.g., bank accounts, crypto accounts, credit/debit card accounts). In some embodiments, an in-person transaction is a cryptocurrency (e.g., token, NFT) exchange. The transaction record server 130 may reflect the exchange in its ledger. In some cases, the transaction record server 130 may also manage blockchain wallets on behalf of the users. If the exchange is to be directly performed on the blockchain, the transaction record server 130 may broadcast the transaction to the blockchain to complete the transaction as a new block is generated. In some embodiments, the blockchain transaction, such as the broadcast of the transaction, is directly done by the application 118 from the individual user device 110.

In some embodiments, an in-person transaction request may be a checkout process between a smartphone of a user and a POS device of a merchant. Both the smartphone and the POS device may be examples of the user devices 110 and the POS device may update the purchase record to the transaction record server 130. Other suitable record keeping and related actions may also be performed by the transaction record server 130.

The data store 135 includes one or more storage units such as memory that takes the form of non-transitory and non-volatile computer storage medium to store various data. The computer-readable storage medium is a medium that does not include a transitory medium such as a propagating signal or a carrier wave. The data store 135 may be used by the transaction record server 130, and/or the user device 110 to store relevant data related to authentication. In some embodiments, the data store 135 communicates with other components by the network 160. This type of data store 135 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 135 is a storage device that is controlled and connected to the transaction record server 130. For example, the data store 135 may take the form of memory (e.g., hard drives, flash memory, discs, ROMs, etc.) used by the transaction record server 130 such as storage devices in a storage server room that is operated by a server.

A blockchain 150 may be a public blockchain that is decentralized, a private blockchain or a semi-public blockchain. A public blockchain network includes a plurality of nodes that cooperate to verify transactions and generate new blocks. In some implementations of a blockchain, the generation of a new block may also be referred to as a mining process or a minting process. Some of the blockchains 150 support smart contracts, which are a set of code instructions that are stored on a blockchain 150 and are executable when one or more conditions are met. Smart contracts may be examples of autonomous program protocols 155. When triggered, the set of code instructions of a smart contract may be executed by a computer such as a virtual machine of the blockchain 150. Here, a computer may be a single operation unit in a conventional sense (e.g., a single personal computer) or may be a set of distributed computing devices that cooperate to execute the code instructions (e.g., a virtual machine or a distributed computing system). A blockchain 150 may be a new blockchain or an existing blockchain such as BITCOIN, ETHEREUM, EOS, NEO, SOLANA, AVALANCHE, etc.

The autonomous program protocols 155 may be tokens, smart contracts, Web3 applications, autonomous applications, distributed applications, decentralized finance (DeFi) applications, protocols for decentralized autonomous organizations (DAO), non-fungible tokens (NFT), and other suitable protocols and algorithms that may be recorded on a blockchain.

The communications among the user device 110, the transaction record server 130, the autonomous application 124, and the blockchain 150 may be transmitted via a network 160, for example, via the Internet. In some embodiments, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet switching networks such as the Internet.

### Example Transaction Process

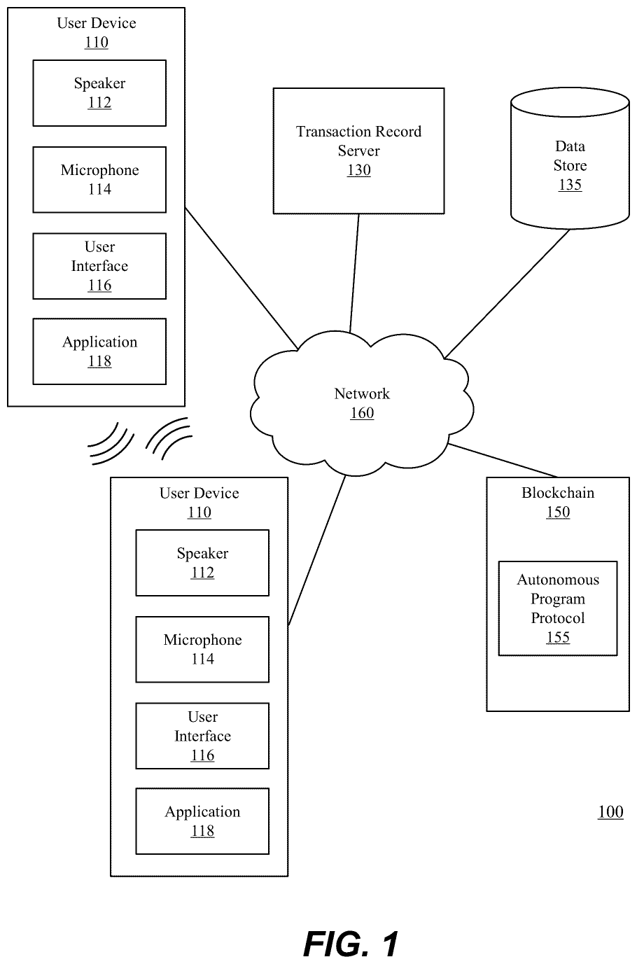

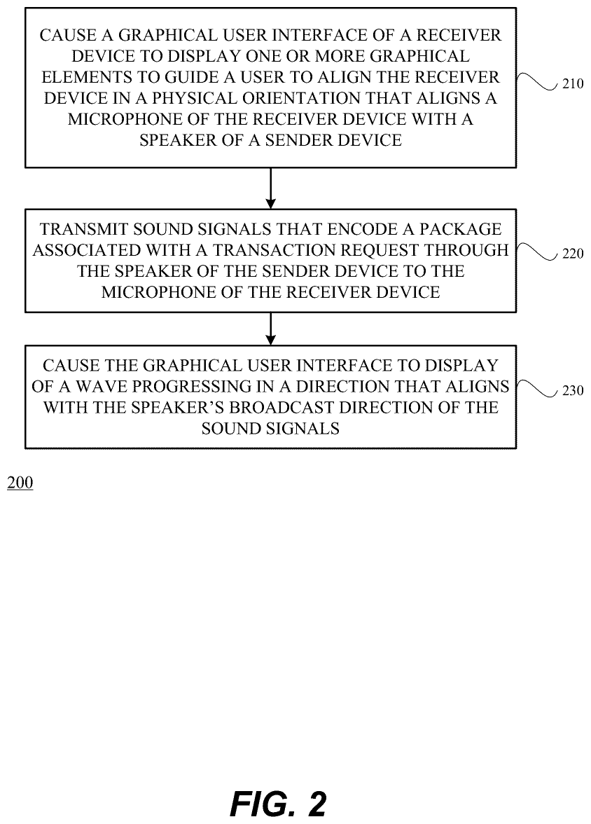

FIG. 2 is a flowchart depicting an example process 200 for providing a user interface for contactless in-person transaction via sound. The process 200 may be embodied as a combination of hardware and a software algorithm that may be stored as computer instructions that are executable by one or more processors. The instructions, when executed by the processors, cause the processors to perform various steps in the process 200. In various embodiments, the process 200 may include additional, fewer, or different steps.

At 210, the process includes causing a graphical user interface of a receiver device to display one or more graphical elements to guide a user to align the receiver device in a physical orientation that aligns a microphone of the receiver device with a speaker of a sender device.

For example, a speaker of a sender device can generate an audio signal (or a sound signal) that encodes a package associated with a transaction request. For example, a first application installed on the device can cause the speaker to generate the audio signal.

The audio signal can include high-frequency sound. For example, the audio signal can be ultrasound or near-ultrasound sound that is inaudible. For example, the audio signal can be an inaudible sound that is in a frequency range of human hearing. For example, the audio signal can be masked to be imperceptible to human hearing. For example, the audio signal can have the frequencies in the inaudible ranges of 20,000 Hz to 22,000 Hz and in the less inaudible range of 16,000 Hz to 19,000 Hz. The volumes of the devices producing the audio signal may be in the range of 1 dB to 84 dBs.

The receiver device can have a graphical user interface configured to display graphical elements to guide a user to align the receiver device in a physical orientation that aligns a microphone of the receiver device with a speaker of the sender device.

At 220, the process includes transmitting sound signals that encode a package associated with a transaction request through the speaker of the sender device to the microphone of the receiver device. In some embodiments, the package associated with the transaction request can include a file format such as: a user identifier, a merchant identifier, a payment processor, a payment gateway, a transaction type, a payment total, a currency code, a wallet address, an IP address, a public key, and an encryption key.

Packages associated with a transaction request can be encrypted prior to transmission. In some embodiments, the audio signal can be modulated using frequency-shift keying (FSK), binary frequency-shift keying (BFSK), continuous-phase frequency-shift keying (CPFSK), Gaussian frequency-shift keying (GFSK), minimum-shift keying (MSK), differential phase-shift keying (DPSK), offset quadrature phase-shift keying (OQPSK), or continuous phase modulation (CPM).

At 230, the process includes causing the graphical user interface to display of a wave progressing in a direction that aligns with the speaker's broadcast direction of the sound signals. For example, the receiver device includes a graphical user interface configured to display a wave progressing in a direction that aligns with the speaker's broadcast direction of the sound signals. The receiver device can also include a graphical user interface configured to display a notification regarding the transaction.

In some embodiments, the receiver device can include a graphical user interface to display one or more graphical elements representing a distance between the speaker of the sender device and the microphone of the receiver device.

In some embodiments, the receiver device can include a graphical user interface to display maintenance of the microphone of the receiver device within a predetermined distance to the speaker of the sender device to improve transmission of the sound signals.

In some embodiments, the receiver device can include a graphical user interface to display listening by the receiver device for sound signals that encode packages associated with transaction requests.

Once the audio signal is received at the receiver device, the received audio signal can be decoded to access the transaction request. For example, an application can decode the audio signal to retrieve the transaction request. Information related to the transaction request can be transmitted to a transaction record server.

The present transaction request protocol presents significant advantages over the prior art. For example, it is known that some current payment platforms have walls to curb competitions and achieve market dominance. For example, some platforms do not allow payment transactions unless a fee is paid. For example, some platforms do not allow people to perform payment transactions unless the transaction is performed on a specific device provided by such platforms. Furthermore, if transaction requests were to be implemented on protocols like Bluetooth or Wi-fi, the user experience would be likely be unpleasant and/or the transaction requests would probably hit technology walls put up by the aforementioned platforms.

Advantageously, the present transaction request protocol enables communication of transaction requests using sound as the data transport medium. The present protocol offers significant advantages because it is platform-agnostic such that it can be used with any type of devices as long as they include a speaker and/or a microphone. Therefore, the present protocol works regardless of the underlying systems technology or architecture. For example, this is the type of protocol that can be made a cross-platform standard.

In some embodiments, an application can decode the received audio signal to retrieve the transaction request. Once the transaction request has been retrieved, the application can interact with the transaction request and use a transaction service to process the transaction associated with the transaction request. For example, the receiver device can include a graphical user interface to display to display one or more graphical elements representing an interaction between the decoded package and a transaction service to process the transaction.

The application can communicate with the transaction service by using application programming interfaces (APIs).

In some embodiments, the transaction service can be a software application that provides a service for file transfer.

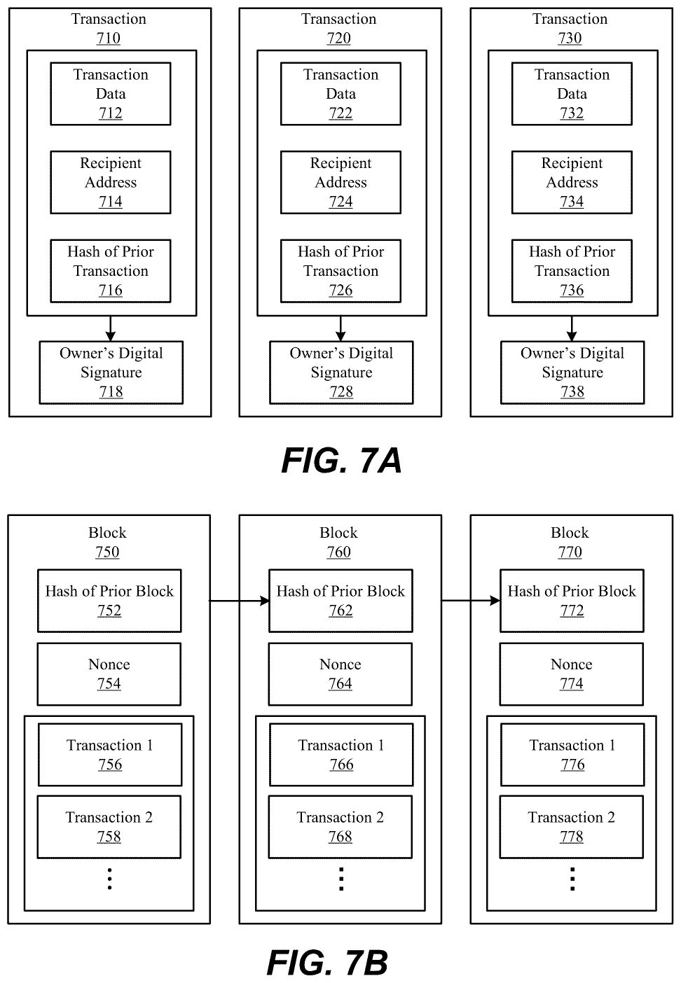

In some embodiments, the transaction service can be a software application that provides a payment service, such as a payment processing software. Examples of payment processing software can include blockchain applications as shown in FIGS. 7A and 7B, which are discussed further in the present disclosure.

The in-person contactless communication protocol may take the form of a peer-to-peer protocol with algorithms that enable instant in-person contactless transaction requests using sound as the data transport medium. The frequencies of the audio signal, in some embodiments, can be high frequency sound audio but are generally adjusted as needed. The protocol works via one device initiating instructions from any computer devices' speakers to broadcast audio signals that are encoded with data. The protocol utilizes microphone on another device to recognize the initiation of the protocol. The microphone may be always-on or may be turned on by the use of application 118. The recipient user device 110 may receive and process the audio signals and execute actions based on instructions contained within the broadcasted data. Actions that the recipient user device 110 may execute include sending a transaction, signing and sending a cryptographic signature using a public private key pair, etc.

In some embodiments, the protocol can be initiated by specifying the chosen sound frequency desired to operate on which may be configured on any number of user devices 110 that are desired to communicate with each other on said frequency. The protocol can take control of the microphone 114 and speaker 112, audio cards of the devices, and can ready the microphone 114 and speaker 112 for sending and receiving data in the form of packets. In some embodiments, the protocol operates in two modes: an interactive two-way, multi-channel communication mode and a non-interactive one way communication channel. The protocol differentiates those two modes by maintaining one or more active sessions between a single connection (interactive) or not (non-interactive).

### Transaction Request Flow

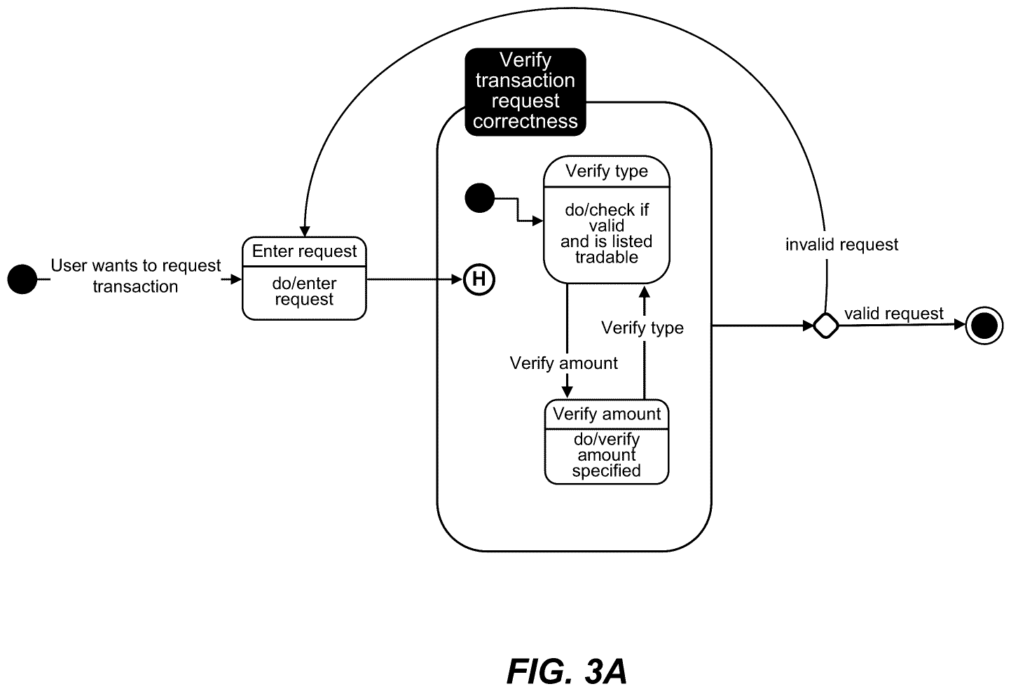

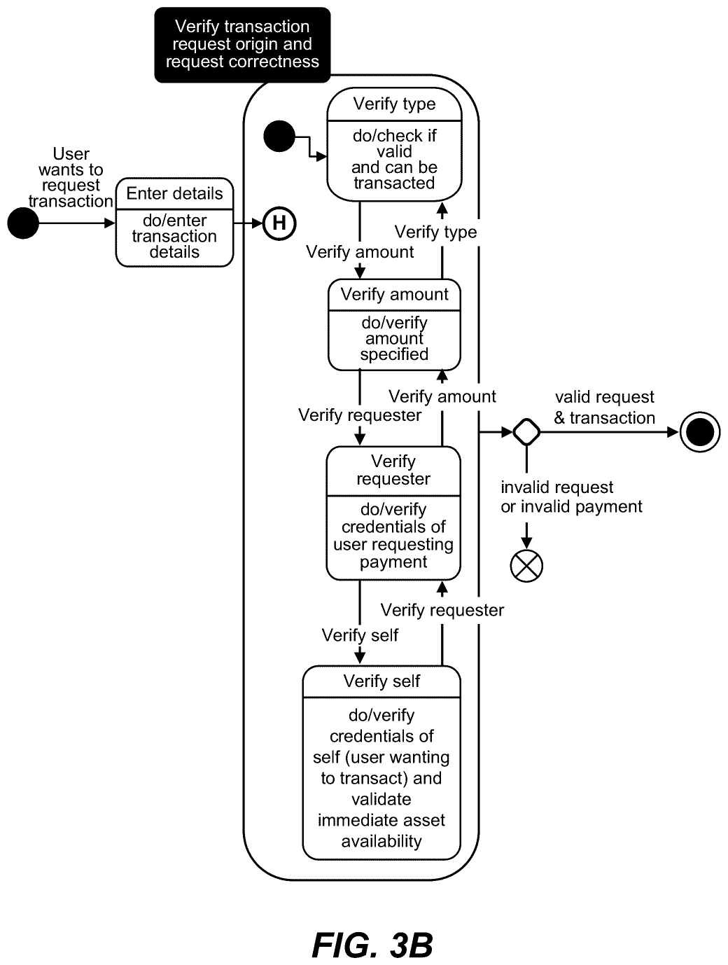

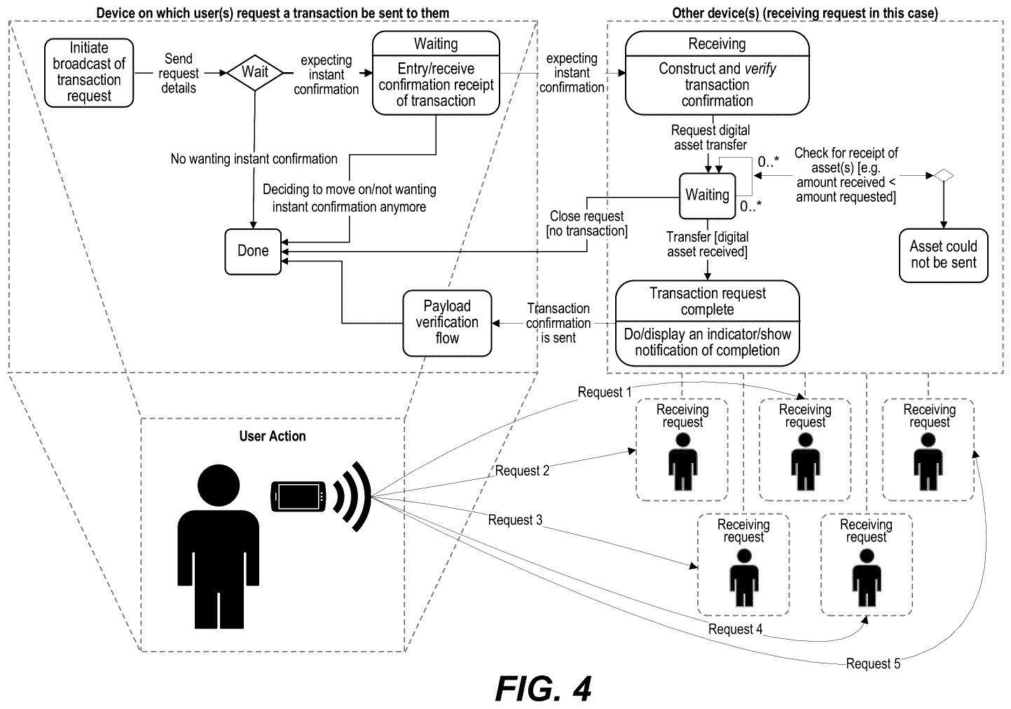

FIG. 3A is a flowchart illustrating an example process for application 118 to initiate and verify a transaction request, in accordance with some embodiments. FIG. 4 is a block diagram illustrating an example overall transaction process in both the transmitter and receiver sides.

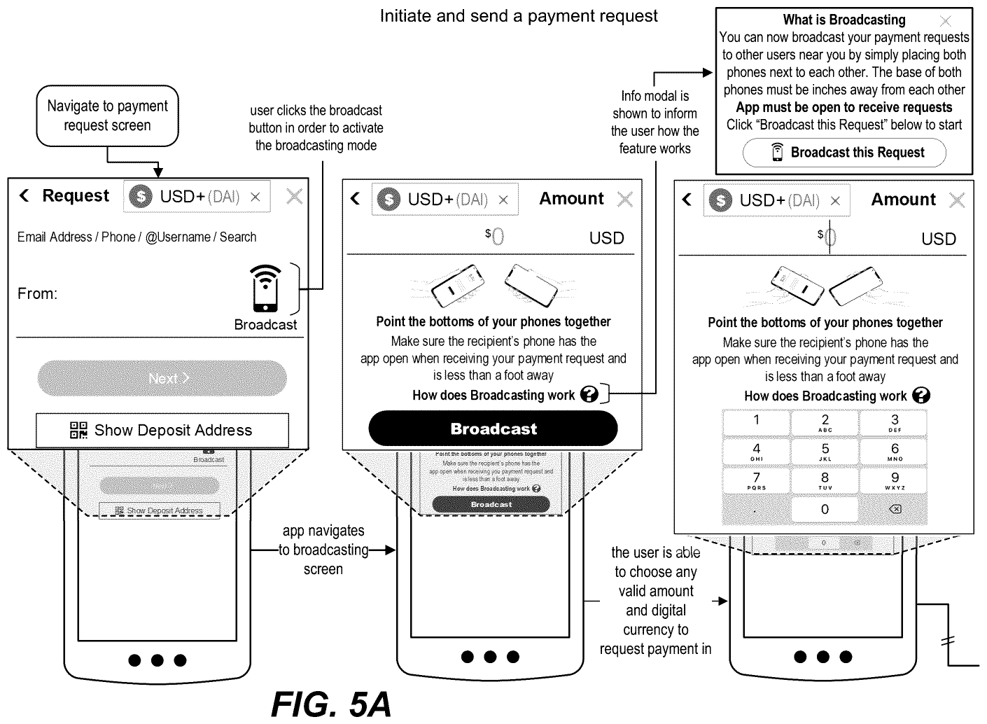

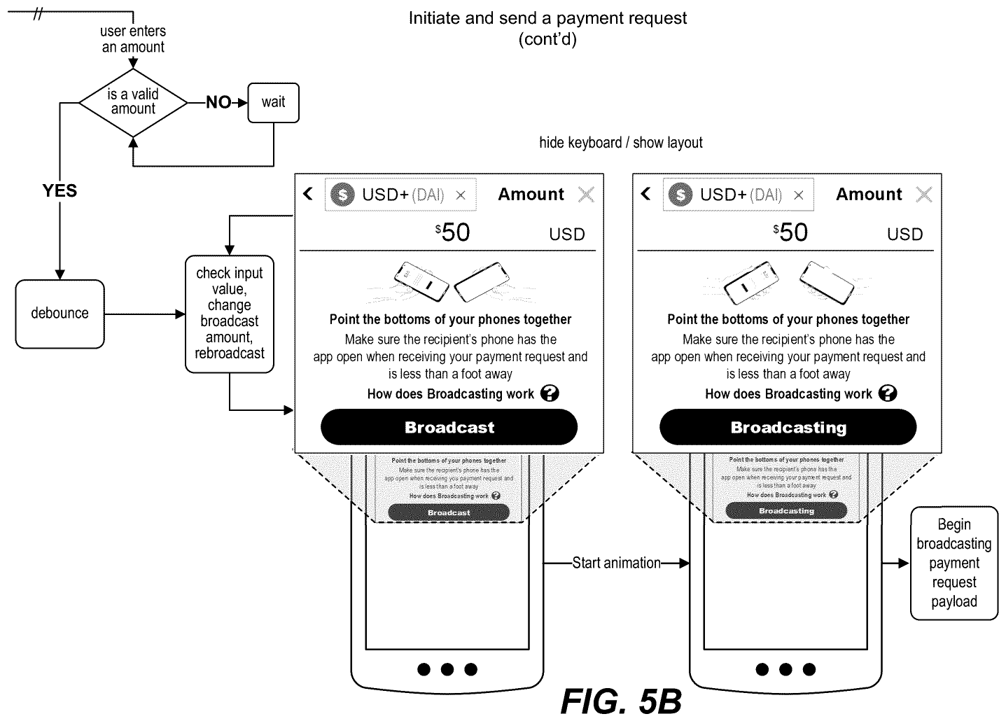

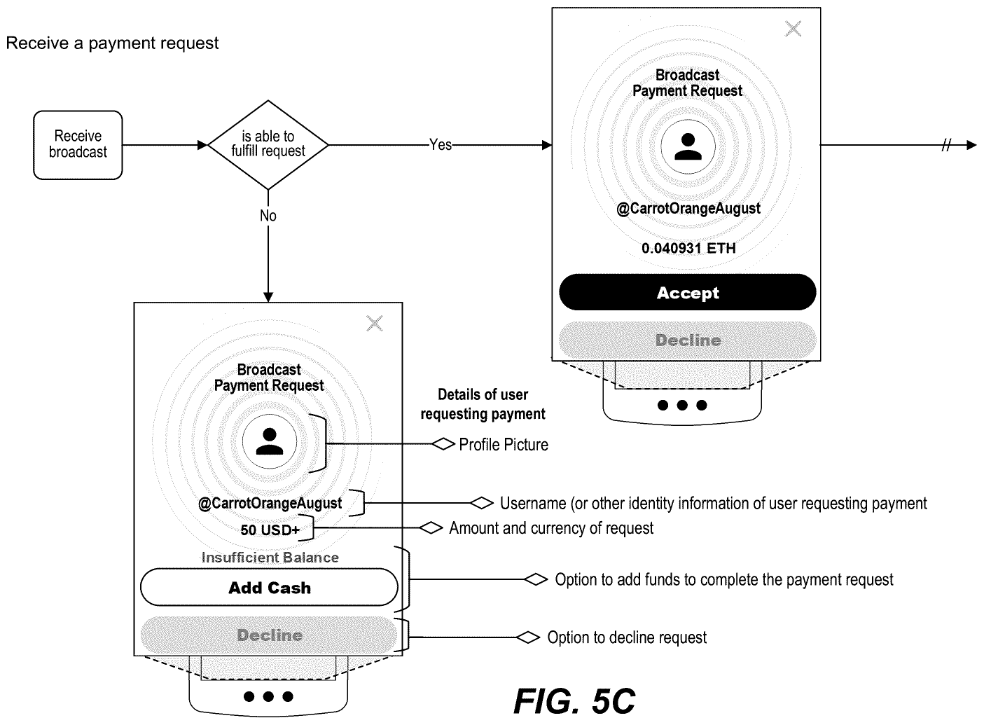

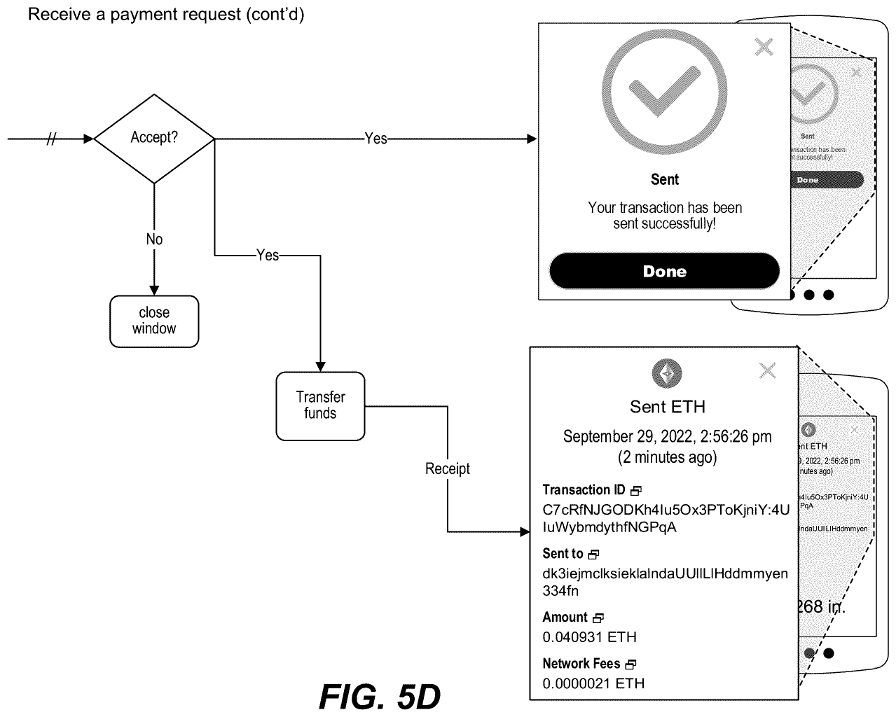

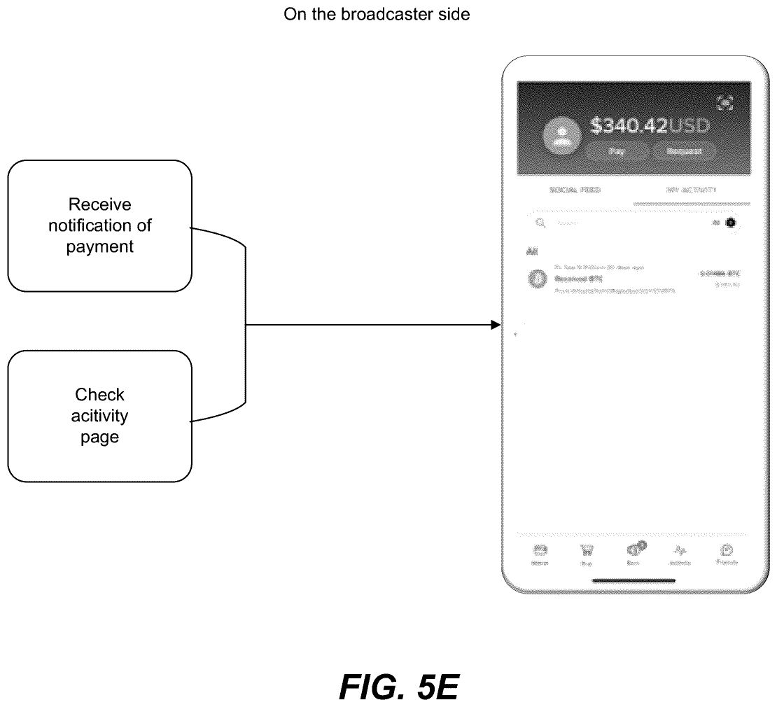

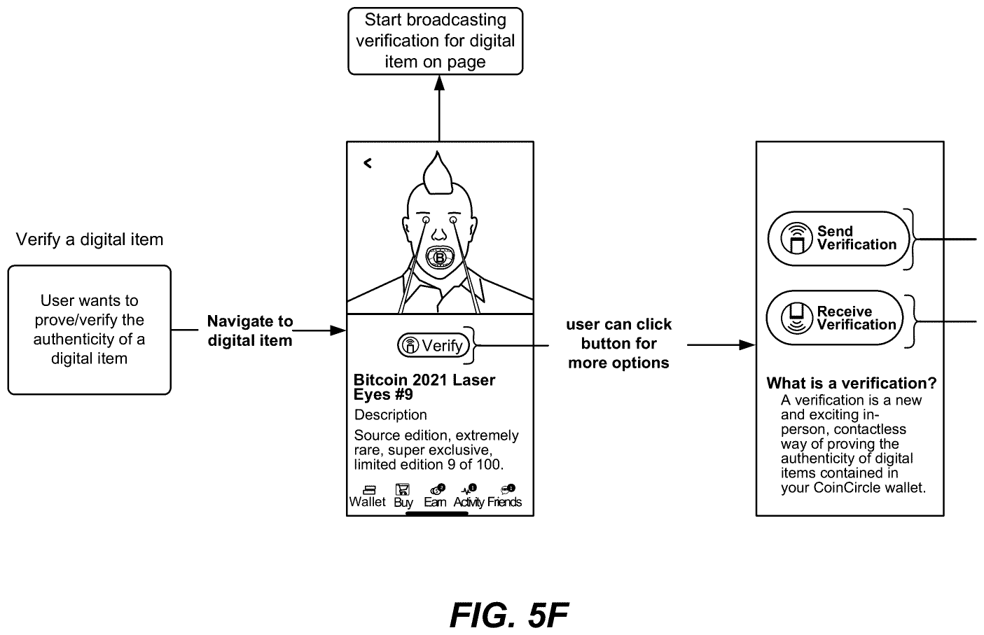

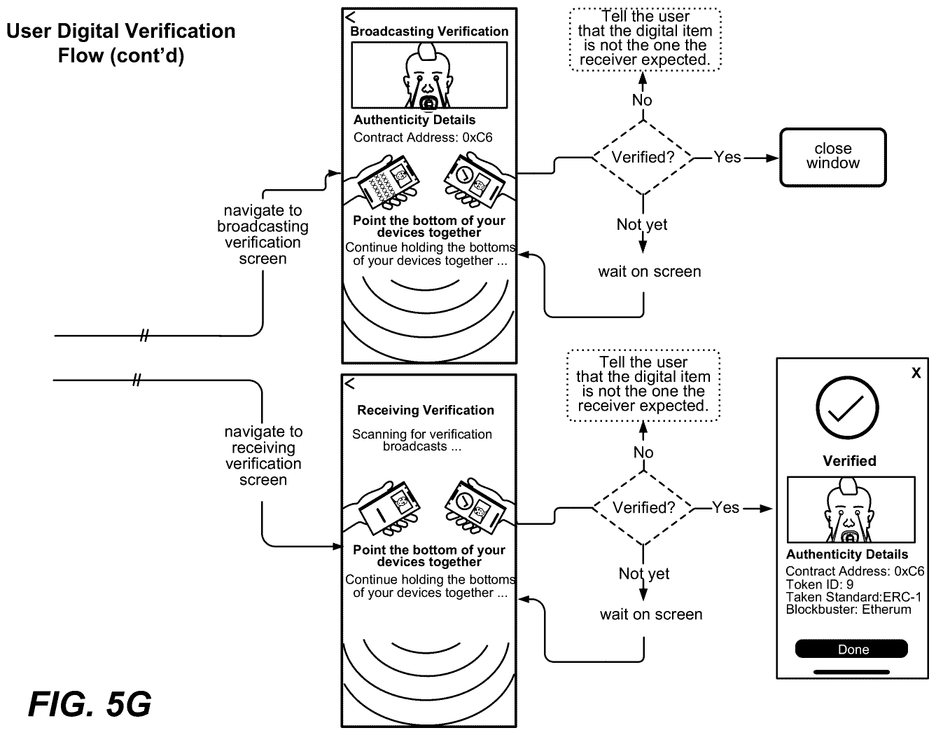

In order to receive transactions via a broadcasting method, the user navigates to the special transaction broadcasting screen in the application 118 in which the users are able to select the desired digital asset and accompanying details (an example is a digital currency and a payment amount). After a short interval of time (in the millisecond range) of verification in the backend that is shown in FIG. 3A, the input is debounced after being verified upon which the input keyboard is hidden and a wave animation is displayed to indicate to the user that a broadcasting is in session. On the screen, the user is instructed to point and position their device within a foot away from the other device(s) in order to broadcast the transaction request successfully. FIG. 3B is a flowchart illustrating another example process for application 118 to initiate and verify a transaction request, in accordance with some embodiments. FIGS. 5A and 5B, combined, are a graphical flowchart that illustrates the change in the graphical user interface 116 of the application 118 in an initiation of an example transaction request, in accordance with some embodiments.

An example of the pseudocode for the broadcaster (transmitter user device 110) is shown below.

```
var timer; // value in seconds
debounce( ) { // debounce routine
  wait(750ms)
  var transaction_details, userDetails =
  parse_user_input( )
  if validate_transaction_details(transaction_details)
  and validate_user(userDetails):
  reset_timer(timer) sender_layer.send(userDetails,
  transaction_details)
  }
while is_on_broadcasting_page( ) do:
  while parse_input_field( ) = = null do:
    wait( ) // do nothing
  if parse_input_field( ):
      debounce( )
// in sender layer
while timer > 0 do:
  block_thread ( )
  var payload =
  create_broadcast_payload(transaction_details,
  userDetails)
  send(payload)
  timer-- // decrement by the same time unit (e.g., ms)
  unblock_thread( )
  free_resources( ) // free control of transmitter
  resources
  start_receiver( ) // start listening again
```

FIGS. 5C and 5D, combined, are a graphical flowchart that illustrates the change in the graphical user interface 116 of the application 118 in receiving a transaction request on a receiver user device 110, in accordance with some embodiments. Upon receiving a broadcast transaction request, the user is shown a screen that slides from the bottom of the screen that lays out the transaction request details: the broadcaster's user details (such as profile picture and/or the broadcaster's username) as well as the transaction details (for example, payment amount and digital currency). In the event that the user does not have the sufficient items/funds to carry out the transaction, they are given the option to add more resources (for example digital items or digital funds), if possible, to resume the request or decline the request altogether. In the event that the user does in fact have sufficient resources, they are able to accept the transaction request after which they are greeted with a success screen and a receipt of the transaction. On the broadcaster side, the user sees a notification confirming the successful transaction. FIG. 5E is a conceptual diagram showing a confirmation notification on the transmitter user device 110, in accordance with some embodiments.

An example of the pseudocode for the receiver (receiver user device 110) is shown below.

```
var incoming_packet = receive( )
var payload= parse_packet(incoming_packet) if
validate_payload(payload):
  block_thread ( )
  var transaction_details, user details
  get_details(payload)
  show_transaction_modal(transaction_details,
  user_details)
  unblock_thread( )
```

### Verify Digital Item Flow

FIGS. 5F and 5G, combined, illustrate an example process for user digital item verification that may be carried by the application 118, in accordance with some embodiments. In order to verify a digital item that the user has in their wallet, the user navigates to the application page containing that digital item. Upon which, an immediate verification broadcast is started to ensure a frictionless user experience. In the event that another nearby device is looking to verify that digital item, the verification would then occur seamlessly. By clicking the “Verify” button, the user is given the option to manually navigate to a special broadcasting verification screen in which extra information about the experience is provided.

From the same menu, the user desiring to verify that specific digital item is able to select the “Receive Verification” to navigate to the receiving verification screen. Then, the mobile app starts listening for incoming verification broadcasts of the same digital item. Upon receiving the verification broadcast, an immediate process is started to certify the verification request. Upon successful verification, the user is shown a success screen.

An example of the pseudocode for the digital item verification process is shown below.

```
// user wanting to verify their digital item
is_on_digital_item_page( )
  var current_page = get_current_page( )
  if current_page == digital_item_page or
  current_page == broadcasting_verification_page: return
  true
  else return false
var user= get_current_user( )
var verification confirmation= null
if is_on_digital_item_page( ) and
user_owns_digital_item(user)
  var digital_item_details =
  get_digital_item_from_page( )
  while !verification_confirmation and
  is_on_digital_item_page(user) do:
  var user_details = get_user_details(user)
  sender_layer.send(user_details, digital_item_details)
// user wanting to verify a digital item
var user= get_current_user( )
var user_details = get_user_details(user)
var digital_item_details =
get_digital_item_from_verification_page( )
while is_on_verification_page( ) do:
var incoming_packet = receive( ) var
incoming_verification_request
parse_packet(incoming_packet) var
incoming_digital_item_details =
get_digital_item_details_from_packet(
incoming_verification_request)
if incoming_digital_item_details == digital_item_details:
var is_verified = verify_ownership(incoming_digital_
item_details)
if is verified:
  show_success_screen( )
  var verification_confirmation
  create_verification_payload(user,
  digital_item_details)
  sender_layer.send(user_details,
  verification_confirmation)
else
show_error( )
```

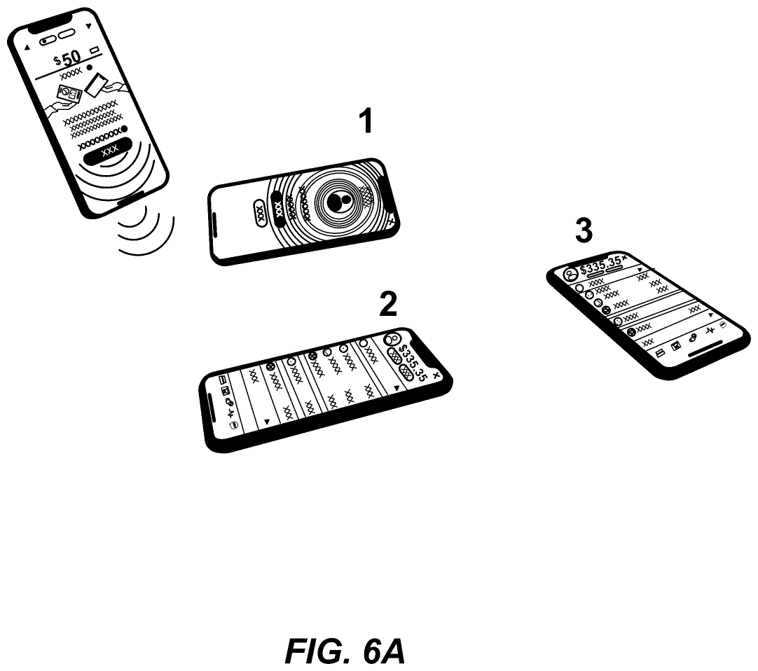

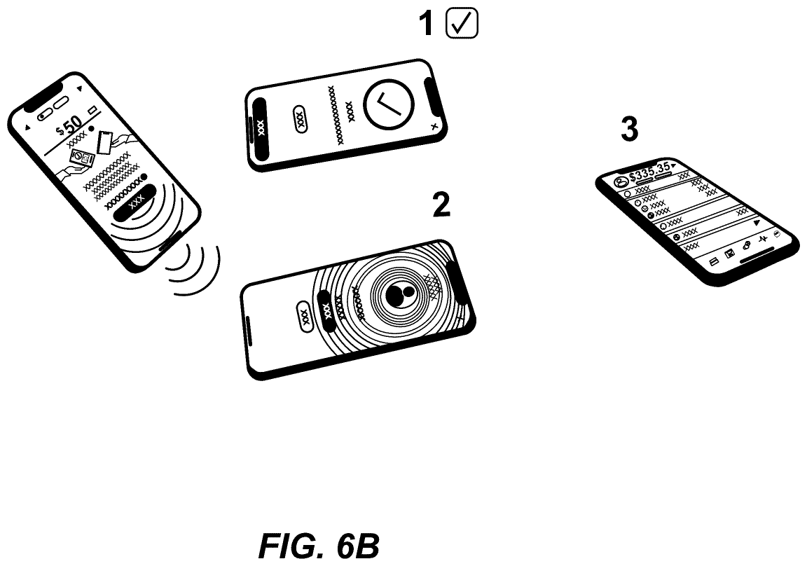

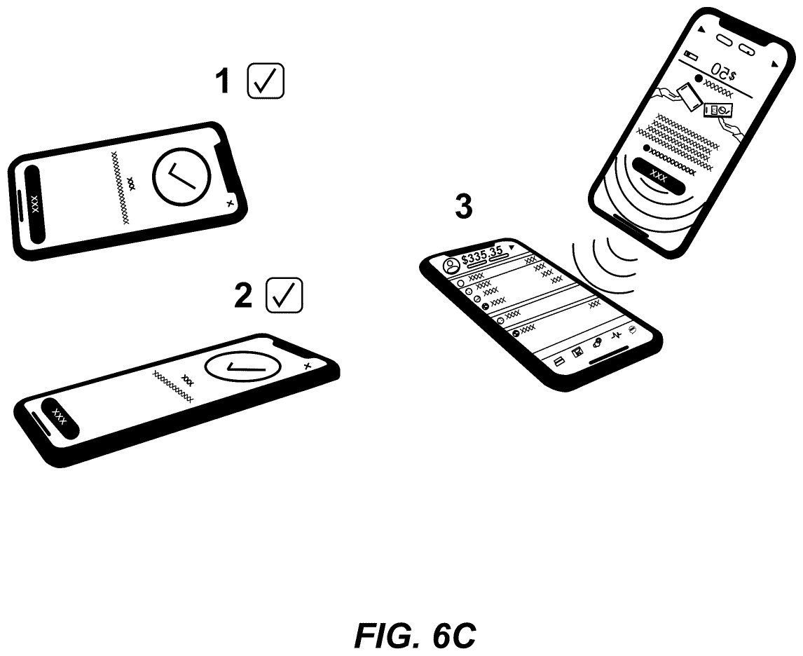

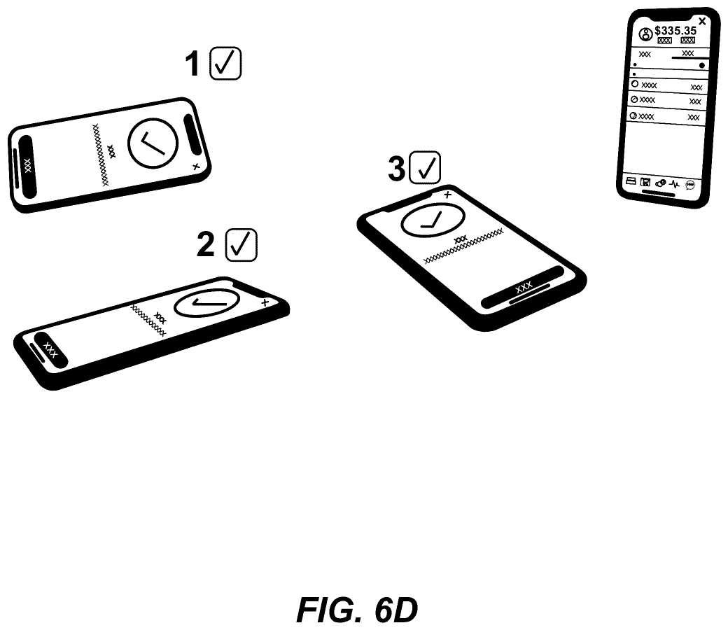

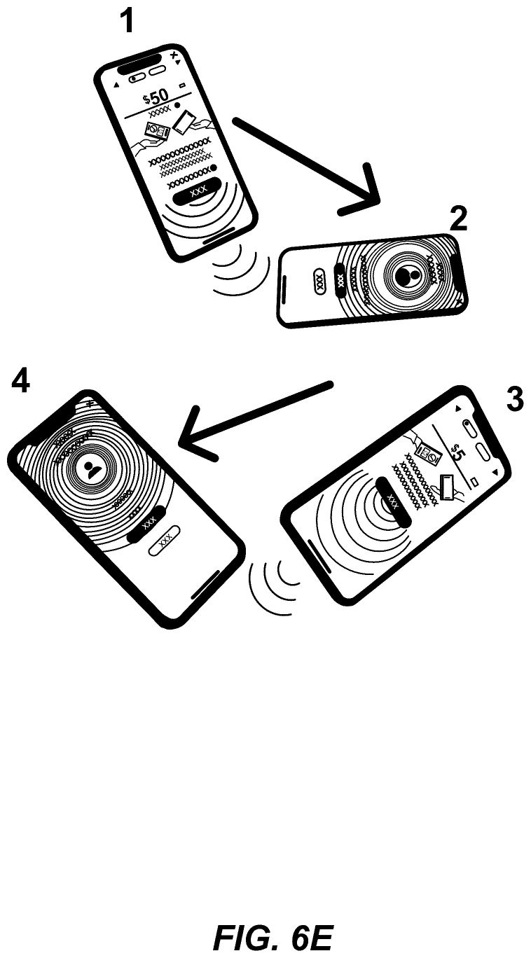

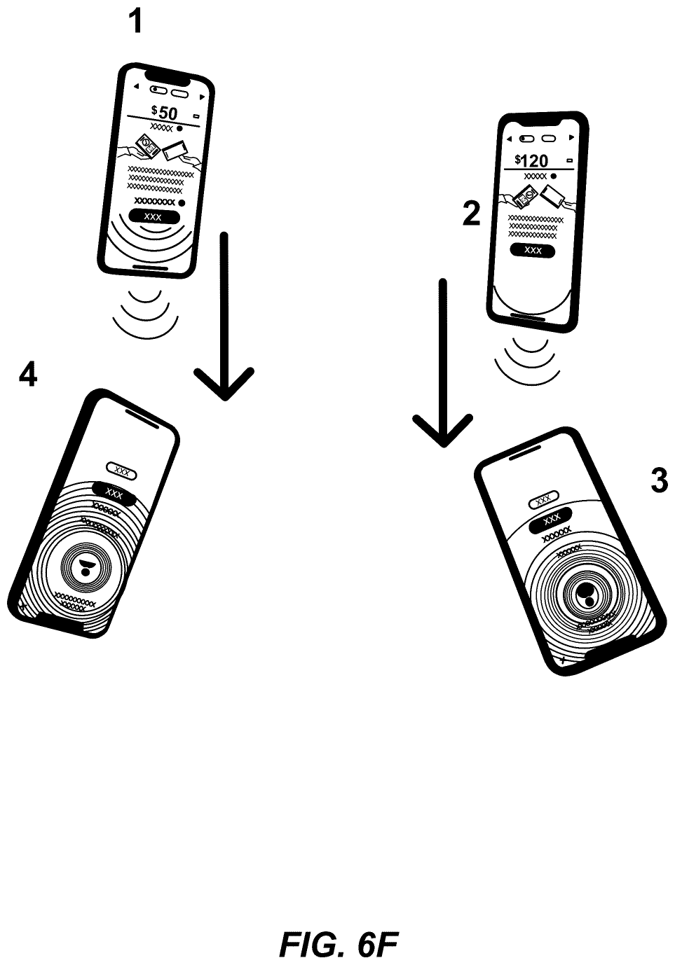

In some embodiments, the application provides the functionality in the form of an ability to “spray and pay” to any number of devices; that is, a one to many relationships in which a device is able to broadcast transactions to any number of nearby devices. A common example of this use case is when wanting to split the dinner bill. A user is able to broadcast their transaction requests to all nearby devices. To do so, the user would navigate through the user transaction request flow (described above). From there, the user simply points their mobile device towards that of any other device that wants to receive the transaction requests. The user is able to quickly broadcast the same request to all nearby devices or adjust each individual transaction request as desired and broadcast it. FIG. 6A through FIG. 6D illustrates an example of a user wanting to broadcast a transaction to 3 nearby devices, in accordance with some embodiments.

While this illustrates a one-to-many relationship, this does not prevent the intercommunication between devices. In other words, a user can complete someone's transaction request and immediately thereafter broadcast a transaction request from any other user nearby (including the user whose transaction request they had just completed, for whatever reason necessary). FIG. 6E through FIG. 6F illustrates transactions between pairs of devices while other devices are in proximity, accordance with some embodiments. In FIGS. 6E and 6F, active peers are marked with arrows and devices are distinguished by their respective numbering.

### Example Blockchain Architecture

FIG. 7A is a block diagram illustrating a chain of transactions broadcasted and recorded on a blockchain, in accordance with an embodiment. The transactions described in FIG. 7A may correspond to any of the transactions and the transfer of blockchain-based units described in previous figures. These steps may occur as two parties complete a transaction using the in-person contactless communication protocol and the transaction is blockchain related.

In some embodiment, a blockchain is a distributed system. A distributed blockchain network may include a plurality of nodes. Each node is a user or a server that participates in the blockchain network. In a public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a private cryptographic key that is used to sign transactions and prove the ownership of a blockchain-based unit.

The ownership of a blockchain-based unit may be traced through a chain of transactions. In FIG. 7A, a chain of transactions may include a first transaction 710, a second transaction 720, and a third transaction 730, etc. Each of the transactions in the chain may have a fairly similar structure except the very first transaction in the chain. The first transaction of the chain may be generated by a smart contract or a mining process and may be traced back to the smart contract that is recorded on the blockchain or the first block in which it was generated. While each transaction is linked to a prior transaction in FIG. 7A, the transaction does not need to be recorded on consecutive blocks on the blockchain. For example, the block recording the transaction 710 and the block recording the transaction 720 may be separated by hundreds or even thousands of blocks. The traceback of the prior block is tracked by the hash of the prior block that is recorded by the current block. In some embodiments, account model is used and transactions do not have any references to previous transactions. Transactions are not chained and does not contain the hash of the previous transaction.

Referring to one of the transactions in FIG. 7A, for illustration, the transaction 720 may be referred to as a current transaction. Transaction 710 may be referred to as a prior transaction and transaction 730 may be referred to as a subsequent transaction. Each transaction includes a transaction data 722, a recipient address 724, a hash of the prior transaction 726, and the current transaction's owner's digital signature 728. The transaction data 722 records the substance of the current transaction 720. For example, the transaction data 722 may specify a transfer of a quantity of a blockchain-based unit (e.g., a coin, a blockchain token, etc.). In some embodiments, the transaction data 722 may include code instructions of a smart contract.

The recipient address 724 is a version of the public key that corresponds to the private key of the digital wallet of the recipient. In one embodiment, the recipient address 724 is the public key itself. In another embodiment, the recipient address 724 an encoded version of the public key through one or more functions such as some deterministic functions. For example, the generation of the recipient address 724 from the public key may include hashing the public key, adding a checksum, adding one or more prefixes or suffixes, encoding the resultant bits, and truncating the address. The recipient address 724 may be a unique identifier of the digital wallet of the recipient on the blockchain.

The hash of the prior transaction 726 is the hash of the entire transaction data of the prior transaction 710. Likewise, the hash of the prior transaction 736 is the hash of the entire transaction data of the transaction 720. The hashing of the prior transaction 710 may be performed using a hashing algorithm such as a secure hash algorithm (SHA) or a message digest algorithm (MD). In some embodiments, the owner corresponding to the current transaction 720 may also use the public key of the owner to generate the hash. The hash of prior transaction 726 provides a traceback of the prior transaction 710 and also maintains the data integrity of the prior transaction 710.

In generating a current transaction 720, the digital wallet of the current owner of the blockchain-based unit uses its private key to encrypt the combination of the transaction data 722, the recipient address 724, and the hash of prior transaction 726 to generate the owner's digital signature 728. To generate the current transaction 720, the current owner specifies a recipient by including the recipient address 724 in the digital signature 728 of the current transaction 720. The subsequent owner of the blockchain-based unit is fixed by the recipient address 724. In other words, the subsequent owner that generates the digital signature 738 in the subsequent transaction 730 is fixed by the recipients address 724 specified by the current transaction 720. To verify the validity of the current transaction 720, any nodes in the blockchain network may trace back to the prior transaction 710 (by tracing the hash of prior transaction 726) and locate the recipient address 714. The recipient address 714 corresponds to the public key of the digital signature 728. Hence, the nodes in the blockchain network may use the public key to verify the digital signature 728. Hence, a current owner who has the blockchain-based unit tied to the owner's blockchain address can prove the ownership of the blockchain-based unit. In this disclosure, it can be described as the blockchain-based unit being connected to a public cryptographic key of a party because the blockchain address is derived from the public key.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 7B is a block diagram illustrating a connection of multiple blocks in a blockchain, in accordance with an embodiment. Each block of a blockchain, except the very first block which may be referred to as the genesis block, may have a similar structure. The blocks 750, 760, and 760 may each include a hash of the prior blockchain 752, a nonce 754, and a plurality of transactions (e.g., a first transaction 756, a second transaction 758, etc.). Each transaction may have the structure shown in FIG. 7A.

In a block generation process, a new block may be generated through mining or voting. For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. When there are multiple candidates new blocks that include different transactions are available, the nodes will vote for one of the blocks to be linked to the existing block. The voting may be based on the voting power of the nodes.

By way of example of a block generation process using mining, in generating the hash of prior block 762, a node may randomly combine a version of the prior block 750 with a random nonce to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes find a hash that satisfies the criteria. The nonce that is used to generate the satisfactory hash is the nonce 764. The node that first generates the hash 762 may also select what transactions that are broadcasted to the blockchain network are to be included in the block 760. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 760 is fixed, the nodes in the blockchain network repeat the trial and error process to generate the hash of prior block 772 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiment, the transaction is considered settled when the transaction is considered final. A transaction is considered final when there are multiple subsequent blocks generated and linked to the block that records the transaction.

In some embodiments, some of the transactions 756, 758, 766, 768, 776, 778, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Computing Machine Architecture

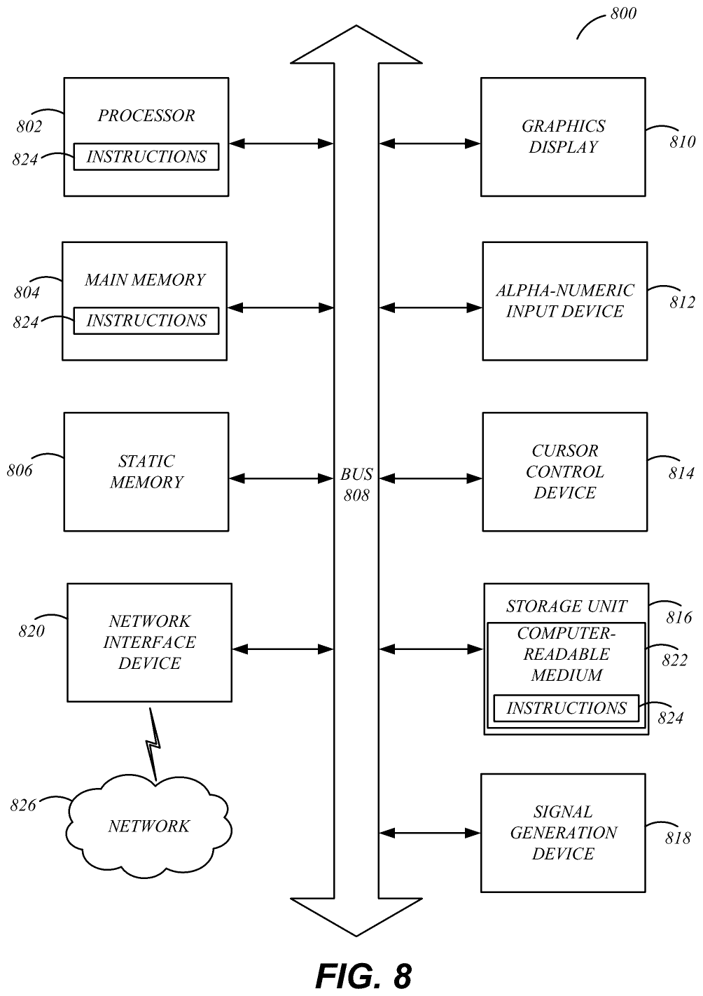

FIG. 8 is a block diagram illustrating components of an example computing machine that is capable of reading instructions from a computer-readable medium and execute them in a processor. A computer described herein may include a single computing machine shown in FIG. 8, a virtual machine, a distributed computing system that includes multiples nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIG. 1, including but not limited to, the user device 110, the transaction record server 130, a node of a blockchain network, and various engines, modules interfaces, terminals, and machines in various figures. While FIG. 8 shows various hardware and software elements, each of the components described in FIG. 1 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors (generally, processor 802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Beneficially, with various embodiments described in this disclosure, in a cryptographically proofed, cost-efficient way, smart contract (or other Web3 application) owners could add an interface to their applications to have control over the applications after being deployed to the blockchain. In addition, the application publishers could also apply security technologies to control the applications in real-time. Since the interactions would be vetted and signed by the access control system before the interaction request reaches the application on the blockchain, the access control server can block and prevent malicious or unwanted actions.

Certain embodiments are described herein as including logic or a number of components, engines, modules, or mechanisms. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A computer-implemented method, comprising:
causing a graphical user interface of a receiver device to display one or more graphical elements to guide a user to align the receiver device in a physical orientation that aligns a microphone of the receiver device with a speaker of a sender device;
transmitting sound signals that encode a package associated with a transaction request through the speaker of the sender device to the microphone of the receiver device; and
causing the graphical user interface to display of a wave progressing in a direction that aligns with the speaker's broadcast direction of the sound signals.

2. The computer-implemented method of claim 1, further comprising:
causing the graphical user interface to display a notification regarding the transaction.

3. The computer-implemented method of claim 1, further comprising:
causing the graphical user interface to display one or more graphical elements representing a distance between the speaker of the sender device and the microphone of the receiver device.

4. The computer-implemented method of claim 1, further comprising:
causing the graphical user interface to display maintenance of the microphone of the receiver device within a predetermined distance to the speaker of the sender device to improve transmission of the sound signals.

5. The computer-implemented method of claim 1, wherein the sound signals comprise inaudible sound that is in a frequency range of human hearing.

6. The computer-implemented method of claim 1, further comprising:
causing the graphical user interface to display listening by the receiver device for sound signals that encode packages associated with transaction requests.

7. The computer-implemented method of claim 1, further comprising:
causing the graphical user interface to display one or more graphical elements representing an interaction between the decoded package and a transaction service to process the transaction.

8. The computer-implemented method of claim 5, wherein the transaction service is a payment service or a file transfer service.

9. The computer-implemented method of claim 1, wherein the sound signals are modulated using frequency-shift keying (FSK),
binary frequency-shift keying (BFSK),
continuous-phase frequency-shift keying (CPFSK),
Gaussian frequency-shift keying (GFSK),
minimum-shift keying (MSK),
differential phase-shift keying (DPSK),
offset quadrature phase-shift keying (OQPSK), or
continuous phase modulation (CPM).

10. The computer-implemented method of claim 1, wherein the package associated with the transaction request comprises a file format including any one of: a user identifier, a merchant identifier, a payment processor, a payment gateway, a transaction type, a payment total, a currency code, a wallet address, an IP address, a public key, and an encryption key.

11. A system comprising:
a sender device configured to generate and transmit sound signals that encode a package associated with a transaction request through the speaker of the sender device, the sound signals being progressed in a direction that aligns with the speaker's broadcast direction of the sound signals;
a receiver device comprising a graphical user interface configured to display one or more first graphical elements to guide a user to align the receiver device in a physical orientation that aligns a microphone of the receiver device with a speaker of a sender device; and
one or more second graphical elements representing a wave progressing in a direction that aligns with the speaker's broadcast direction of the sound signals.

12. The system of claim 11, wherein the graphical user interface is configured to display a notification regarding the transaction.

13. The system of claim 11, wherein the graphical user interface is configured to display one or more graphical elements representing a distance between the speaker of the sender device and the microphone of the receiver device.

14. The system of claim 11, wherein the graphical user interface is configured to display maintenance of the microphone of the receiver device within a predetermined distance to the speaker of the sender device to improve transmission of the sound signals.

15. The system of claim 11, wherein the sound signals comprise inaudible sound that is in a frequency range of human hearing.

16. The system of claim 11, wherein the graphical user interface is configured to display one or more graphical elements representing a listening process by the receiver device for sound signals that encode packages associated with transaction requests.

17. The system of claim 11, wherein the graphical user interface is configured to display one or more graphical elements representing an interaction between the decoded package and a transaction service to process the transaction.

18. The system of claim 11, wherein the transaction service is a payment service or a file transfer service.

19. The system of claim 11, wherein the sound signals are modulated using
frequency-shift keying (FSK),
binary frequency-shift keying (BFSK),
continuous-phase frequency-shift keying (CPFSK),
Gaussian frequency-shift keying (GFSK),
minimum-shift keying (MSK),
differential phase-shift keying (DPSK),
offset quadrature phase-shift keying (OQPSK), or
continuous phase modulation (CPM).

20. The system of claim 11, wherein the package associated with the transaction request comprises a file format including any one of: a user identifier, a merchant identifier, a payment processor, a payment gateway, a transaction type, a payment total, a currency code, a wallet address, an IP address, a public key, and an encryption key.
